(19) United States
(12) Patent Application Publication
(10) Pub. No.: US 2024/0028661 A1
(43) Pub. Date: Jan. 25, 2024

(54) AUGMENTED UI GENERATED THROUGH NATURAL LANGUAGE QUERY AND SEMANTIC DATA CONNECTIONS

(71) Applicant: GOOGLE LLC, Mountain View, CA (US)

(72) Inventors: Andrew Jason Lavery, Austin, TX (US); Michael Vernon Lee, Cedar Park, TX (US)

(21) Appl. No.: 17/814,066

(22) Filed: Jul. 21, 2022

(51) Int. Cl. G06F 16/957; G06F 16/9538; G06F 16/958; G06F 16/906

(52) U.S. Cl. CPC G06F 16/9577; G06F 16/9538; G06F 16/986; G06F 16/906

(57) ABSTRACT

Techniques of modifying user interfaces associated with a browser application includes enabling a user to modify a web page as displayed by the web browser in a way not anticipated by the creators of the web page elements and without needing to understand the internal structure of the web page. For example, improved techniques implemented as part of the technical solution would allow a participant in a web meeting to emphasize the names of other participants having the same manager without knowing anything about the architecture or programming code associated with the web meeting application.

### BACKGROUND

Browsers are applications that allow users to navigate to different websites and to display content, or web pages, generated by the website. Such content can include web page elements (e.g., mark-up language elements, document object model (DOM) objects) that are rendered by the browser to generate a presentation of the web page for display.

### SUMMARY

Implementations described herein are related to enabling a user to modify web page elements displayed by the web browser in a way not anticipated by the creators of the web page elements and without needing to understand the internal structure of the web page. Specially, disclosed implementations take as input a natural language request to modify a presentation of the current webpage as displayed by the browser, identifies data elements within the webpage (mark-up language elements, DOM elements, etc.) and modifies the appearance of the responsive data elements in accordance with the request. In some implementations, the proposed system may access data in a datastore to determine which elements to modify.

In one general aspect, a computer-based method can include receiving, from a user of a web browser, query data representing a request to modify a presentation of a web page as displayed by the web browser, the web page including structured data elements and the request identifying a criterion. The computer-based method can also include analyzing the web page to identify a structured data element of the structured data elements that satisfies the criterion. The computer-based method can further include applying a modification to the structured data element satisfying the criterion to produce a modified presentation of the web page as displayed by the web browser.

In another general aspect, a computer program product comprises a non-transitory storage medium, the computer program product including code that, when executed by processing circuitry of a computing device, causes the processing circuitry to perform a method. The method can include receiving, from a user of a web browser, query data representing a request to modify a presentation of a web page as displayed by the web browser, the web page including structured data elements, and the request identifying a criterion. The method can also include analyzing the web page to identify a structured data element of the structured data elements that satisfies the criterion. The method can further include applying a modification to the structured data element satisfying the criterion to produce a modified presentation of the web page as displayed by the web browser.

In another general aspect, an electronic apparatus comprises memory and controlling circuitry coupled to the memory. The controlling circuitry can be configured to receive, from a user of a web browser, query data representing a request to modify a presentation of a web page as displayed by the web browser, the web page including structured data elements and the request identifying a criterion. The controlling circuitry can also be configured to analyze the web page to identify a structured data element of the structured data elements that satisfies the criterion. The controlling circuitry can further be configured to modify the structured data elements satisfying the criterion to produce a modified presentation of the web page as displayed by the web browser.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example modification of a web page element in response to a query from a user.

FIG. 1B is a diagram that illustrates an example electronic environment in which the improved techniques described herein may be implemented.

FIG. 2 is a diagram that illustrates example processing circuitry in which the improved techniques described herein may be implemented.

FIG. 3 is a diagram that illustrates example web elements, including structured data elements, in a web page.

FIG. 4 is a diagram illustrating an example external dataset for modifying a web element of a web page.

FIG. 5 is a diagram illustrating an example external dataset for modifying a web element of a web page.

FIG. 6 is a diagram that illustrates an example method of performing the improved techniques described herein.

FIG. 7 is a diagram that illustrates an example of a computer device and a mobile computer device that can be used to implement the described techniques.

FIG. 8 is a diagram that illustrates an example of a distributed computer device that can be used to implement the described techniques.

### DETAILED DESCRIPTION

Users of web pages frequently wish to modify those web pages to extract further information than what is being presented on the web pages. For example, consider a web meeting application that arranges identifiers (e.g., names, avatars) of meeting participants in a column aside a window showing a live stream of the meeting. In the conventional approaches to modifying a web page, the user would only be able to make changes to the interface implemented by the application developer. If the user wished to emphasize (e.g., highlight, bold, blink, etc.) the identifiers of those participants that report to the same manager as the user, the user would not be able to because the web developer did not allow for the user to do so. Disclosed implementations can implement such a request by enabling the user to modify a web page even when the web developer did not design the web page with such modifications built in. The enablement may take the form of a natural language query that may be interpreted by a natural language processor in conjunction with semantic information in the web page.

The query represents a request to modify web page elements according to a criterion. The criterion may identify a target of an emphasis operation (e.g., highlighting) based on a structured data element (e.g., semantic markup element, table element, list, etc.) representing the target; the web browser determines which structured data elements may be relevant to the target of the emphasis operation. The natural language processor is then configured to determine the criterion based on the query and semantic information. For example, for the query, “highlight meeting participants who have the same manager as me,” the criterion is “same manager as me.”

To identify the target of the emphasis operation, however, the disclosed implementations may seek to access an external dataset. Along these lines, there may be associations between the structured data elements and external datasets that make it possible to determine the association via a natural language query that includes the criterion. For example, in the above query, the disclosed implementations may involve identifying and searching/sorting through a human resources database to locate the managers of the participants and determine those participants represented by structural data elements satisfying the criterion. This provides a user with the ability to modify any web page with semantic information through which the web browser may interpret the data in the web page because the data is in a machine-readable format through semantic metadata.

Some approaches to modifying browser application user interfaces include browser extensions that enable a user to manipulate web elements of a user interface. These approaches, however, are brittle to changes of the interface by creators of respective browser applications and require some level of programming experience (understanding detailed information about how the web application is structured and understanding browser script, e.g., JavaScript®. Accordingly, most users cannot feasibly modify browser application views, and for those that can, the modification can break, e.g. when the creator or provider of the webpage changes or redesigns the structure and arrangement of elements include in the web page, without notice, requiring the modification to be rebuilt.

A technical problem with the above-described conventional approaches is that while web page creators may provide some options to the user to customize the web application user interface, those customizations are limited and static. Conventional third-party approaches to modifying web application user interfaces have controls that enable a user to manipulate elements of a user interface. The conventional approaches to modifying web application user interfaces (e.g., with extensions) are brittle to changes of the interface by creators of respective browser applications. Therefore, it is not feasible for a user of a conventional browser application to augment web application views without knowing detailed information about how the web application is structured, and manually creating brittle custom browser extensions (in a browser script, e.g., JavaScript®) to modify the web page elements.

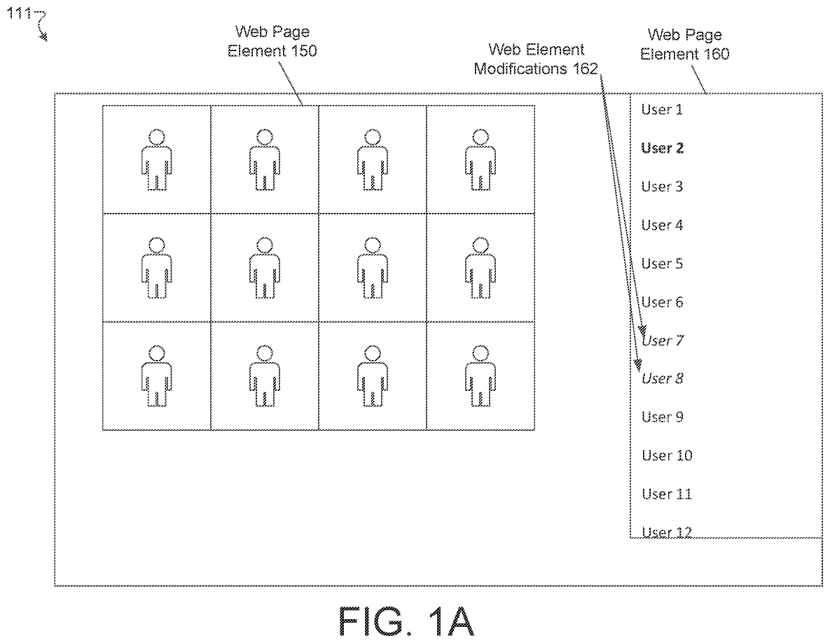

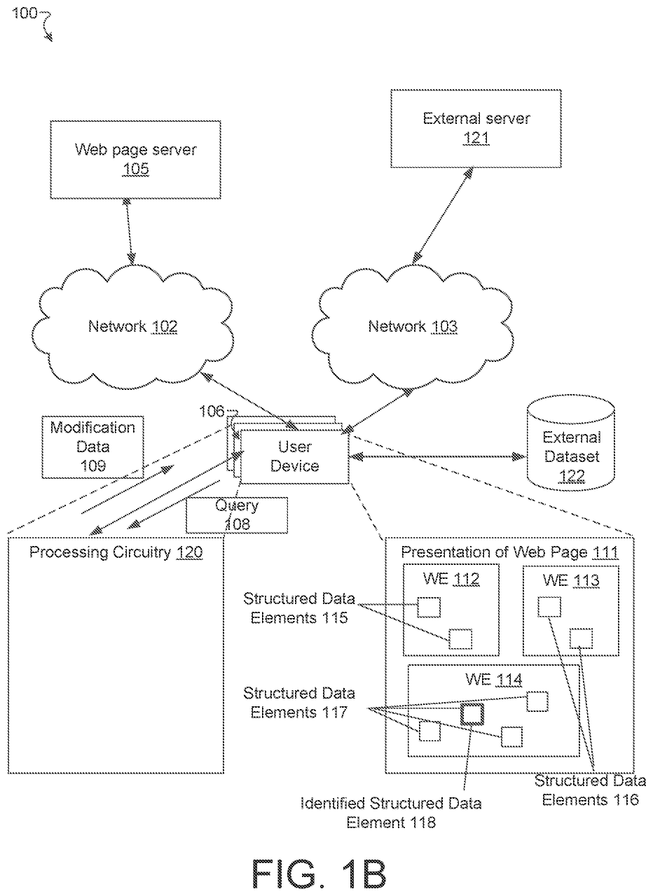

In accordance with the implementations described herein, a technical solution to the above-described technical problem includes enabling a user to modify a web page as displayed by the web browser in a way not anticipated, e.g., beyond any options provided to the user, by the creators of the web application and without needing to understand the internal structure of the web page. For example, improved techniques implemented as part of the technical solution would allow a user to emphasize the names of participants having the same manager without knowing anything about the architecture or programming code associated with the web meeting application, as shown in FIG. 1A. The disclosed system includes processing circuitry that allows the user to submit a query that refers to a criterion satisfied by structured data elements in the web page.

In the improved techniques, a browser enables the user to modify (e.g., augment) a presentation of the web page as displayed by the browser by parsing a natural language query, identifying a criterion in the query, analyzing structured data elements on the web page, and potentially one or more known external datasets, to evaluate the criterion and identify structured data elements to modify. The browser accomplishes this by receiving a natural language query provided by the user that includes the criterion.

A natural language query is processed using a natural language processor. Natural language processing is concerned with interactions between computers and human language, in particular how to program computers to process and analyze large amounts of natural language data. The goal is a computer capable of “understanding” the contents of documents, including the contextual nuances of the language within them. A natural language processor can accurately extract information and insights contained in the documents as well as categorize and organize the documents themselves. Processing a query using a natural language processor, when the query is written in natural language, is advantageous because the processor, in conjunction with markup language information in the web page, can interpret a user's intent far more accurately than a conventional query parser.

The query represents a request to modify, e.g., structured data elements, that satisfy the criterion. The criterion may identify an emphasis operation and a target of the emphasis operation. The browser analyzes the web page elements to identify elements, including data structured elements (such as semantic markup elements, table elements, lists, etc.). The browser determines which structured data elements may be relevant to the target of the emphasis operation. For example, some web page elements may be used to identify other web page elements to which the emphasis operation is applied. These elements (to which the target operation is applied) may be referred to as web elements having structured data elements that satisfy the criterion. The browser may also, based on the query criterion, identify and retrieve the one or more known external datasets, which may be stored locally (including an open browser tab and/or a dataset associated with the user, such as a shopping list or list of interests) or on a server other than that hosting the web page. The browser uses information from the one or more external datasets, along with the semantic information, to modify a presentation of the web page as intended by the user.

A technical advantage of disclosed implementations is that the improved techniques enable the user to modify a presentation of the web page without requiring the user to be aware of the internal structure and elements of the web page and/or requiring that the user creating a specialized browser extension on her own, e.g., through the use of natural language commands. Specifically, implementations can identify structured data elements in the web page identified by the semantic information and can cross-reference the structured data elements with the external datastore to identify structured data elements responsive to the request. Implementations can modify these responsive data elements in the current web page to change the appearance of those elements. Moreover, to ensure privacy, data from the external datastore remains local to the computer running the browser and is not sent to a server associated with the web application. Thus, the modification of the presentation of the web page can be accomplished without sending any data to a server hosting the web page.

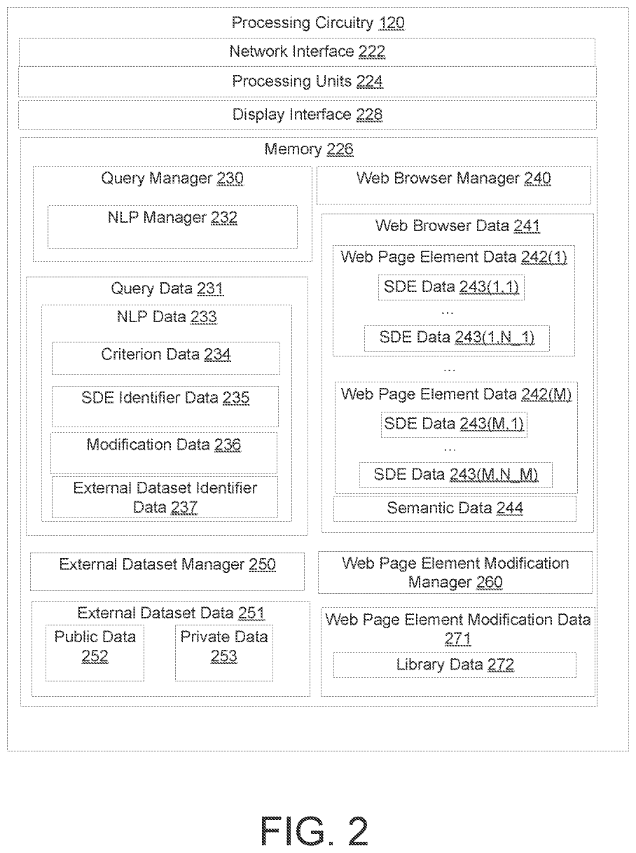

FIG. 1A is a diagram that illustrates an example modification of a presentation of the web page, e.g., user interface 111, in response to a query from a user. This example is not intended to be limiting and is presented for ease of discussion. The user interface 111 as shown in FIG. 1A displays information for a participant of a web meeting. The user interface 111 displays web page elements 150 and 160. The web page element 150 displays avatars or video streams of the participants, arranged in an array. The web page element 160 displays a list of participant names. For example, as displayed in FIG. 1A, the name “user 2” is bolded; this may be the participant's name and may be a default setting for the web meeting application. When the participant, however, submits the query, “show the participants having the same manager as me” to processing circuitry 120 (FIGS. 1B and 2) configured to process the query, the processing circuitry 120 carries out the improved techniques by processing the query, identifying a criterion in the query and a modification, identifying an external dataset in which the information about managers is given (e.g., an organizational chart), and applying the criterion from the query to the web page elements in view of external dataset to determine the participants having the same manager as the participant. As shown in FIG. 1A, those participants are User 7 and User 8. Therefore, the processing circuitry 120 italicizes the list elements for User 7 and User 8. It is noted that the word “emphasize” from the query was interpreted by the processing circuitry as the modification, in this case an italicize operation; the result is the web element modifications 162, i.e., a modified presentation of the web page (i.e., modified user interface). In some implementations, the word “emphasize” is used for other modifications such as highlighting, bolding, blinking, etc. In some implementations, other words in the query are interpreted to provide the modification.

In some implementations, the query is input by the user via a keyboard input into a text box input or the like. In some implementations, the query is input by the user via speech, i.e., spoken words from the user input into an application configured to capture and parse the speech into query components (e.g., criterion, targets, modification). In some implementations, the speech is displayed to the user via a speech-to-text application.

In some implementations, the processing circuitry 120 processes the query using a natural language processor. The browser application that receives a natural language query from the participant may use existing natural language processing capabilities (part-of-speech tagging, entity identification, etc.) related to semantic representations, language understanding and question-answering for a search application. The improved techniques leverage such capabilities to understand the intent of natural language requests, in order to translate a query to instructions for fetching data or augmenting the web application interface.

A web browser is application software running on processing circuitry (e.g., processing circuitry 120) for accessing web pages. When a user requests a web page from a website, the web browser retrieves content from a web server renders and displays the content in a browser window on the user's device. A web application is identified by a uniform resource locator (URL) input by the user. A web browser may display multiple web pages within a single user interface; each such web page is activated using a tab, e.g., the top of the user interface. A user of the web browser may activate a different web page by clicking on its tab on the user interface.

A web application is an application developed and stored on a web server by application creators and run within a web browser. The web application defines the web elements rendered by the browser to generate the user interface. Upon receiving a request to access the browser application from a user device (i.e., via a URL), the web server transmits code interpreted (rendered) and run within a web browser on the user device.

A web page element is an object defined by the web application. These include visible elements (e.g., participant lists and participant streaming images in a web meeting application) and non-visible elements (e.g., JavaScript). For example, in the above-discussed web meeting application, the web page elements 150 and 160 contain visual information about the meeting participants and participant names. In a browser application, some web page elements include application data (e.g., meeting participant identifiers, avatars, and photos) and other forms of data including semantic information (e.g., person, movie, director.).

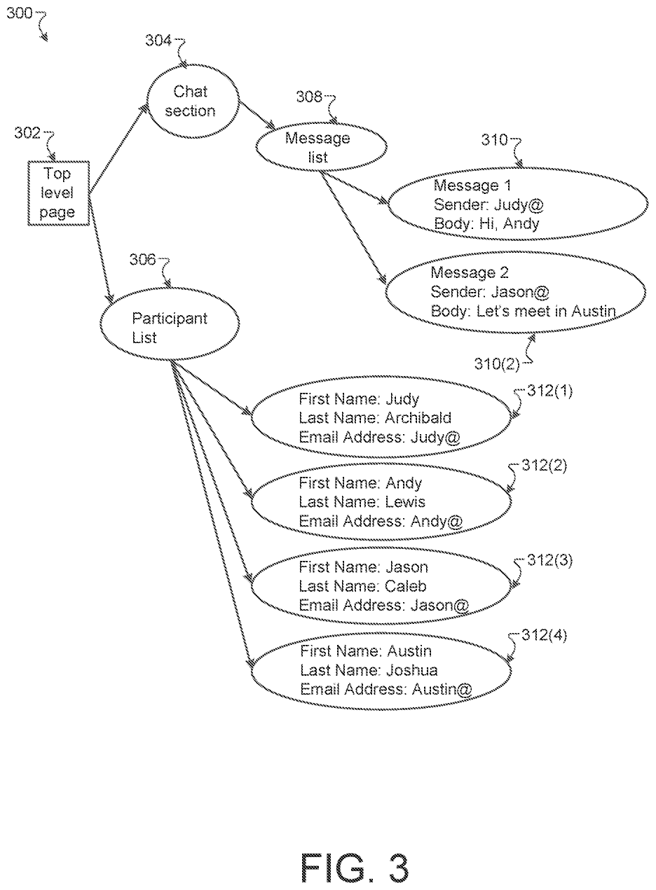

A structured data element is a data object stored in a data structure that provides a hierarchal description of information in a web element and is organized according to a data model. In some implementations, structured data elements conform to a tabular format with relationship between different rows and columns. In this way, different rows and columns may be sorted or searched according to a query. Examples of structured data elements in the context of modifying web page elements are discussed with regard to FIG. 3.

Semantic markup information is markup that reinforces the semantics, or meaning, of the information in web pages and browser applications rather than merely to define its presentation or look. Semantic markup information is processed by traditional web browsers as well as by many other user agents. In addition, other, more detailed semantic markup information is provided in the Semantic Web which includes Resource Description Framework (RDF), Web Ontology Language (OWL), and Extensible Markup Language (XML). HTML describes documents and the links between them. RDF, OWL, and XML, by contrast, can describe arbitrary things such as people, meetings, or cooking ingredients.

In some implementations, the semantic information in the web page is expressed according to the W3C Consortium standard for Semantic Web. Semantic Web allows web pages to encode web page elements with semantics (i.e., meaning). For example, FIG. 1A, the data representing the column of meeting participants in the meeting (i.e., web page element 160) can include metadata to identify that this is a list of participants, and the data elements in the column can be clearly identified, such as First Name, Last Name, LDAP/Email Address, etc., e.g., <div itemscope itemtype=“https://schema.org/Person”> identifies a data element as a person. This enables the browser to interpret the data in the web page because the data is in a machine-readable format through semantic metadata. This example is not limiting and any label field (e.g., a “label” field in a <span> or <div> HTML markup tag) may so identify a data element.

A modification of a presentation of a web page as displayed by a web browser in this context is a change to one or more web elements at the browser that change the appearance of content as displayed within the web browser. In some implementations, the modification is an augmentation to the structured data element in the web browser, e.g., an annotation such as an underline, an asterisk, or the like. In some implementations, the modification is an emphasis such as text italics, change in text color, change in text font, change in text font size, change in background color, bolded text, underlined text, a highlight, or the like. The modification can be referred to as a visual pointer because the modification visually distinguishes the modified element. Thus, a modification can be added web page elements at the browser that, when rendered by the browser, effect a change in appearance of a web page element. In some implementations, the modification is a removal or deletion of displayed data in the user interface or web element. In some implementations, when the structured data element satisfying the criterion includes a table, the modification represents a sort order operation in which, upon application of this modification, table rows are rearranged in the table to produce a modified sort order. In some implementations, when the structured data element satisfying a criterion from a subsequent query includes a table row of list element, the modification includes a resorting (reordering) of the table rows.

In some implementations, a modification may be selected from a library of prespecified modifications, i.e., predefined emphasis operations. Such a library may include modification identifiers and, for each modification identifier, instructions for effecting the modification. For example, a modification identifier for bold can be associated with instructions for applying a markup element (e.g., <b>) to a web page element that satisfies the criterion, where a modification identifier for highlight can be associated with instructions for applying a markup element to change a background color of the web page element that satisfies the criterion. Modification identifiers may be text (e.g., “bold”) or may be any string, number, or combination of these that corresponds to text that may appear in the query. The library can also be used when the query is unclear about the modification. For example, if a query states “show me the participants having the same manager as me,” then the processing circuitry may select a modification at random from the library and implement its instructions. In some implementations, the improved techniques include a default modification in case the query renders the modification as indeterminate. Example instructions include adding markup tags for implementing the prespecified modification. In some implementations, the instructions can be customized by the user (e.g., enabling the user to select the highlight color, the default modification, etc.).

In some implementations, the processing circuitry may be configured to provide an interface that enables the user to select a modification from two or more modifications (e.g., selectable modifications). For example, a query that includes highlight may correspond to two or more modifications in the library, e.g., highlight in blue or highlight in yellow. In such an implementation, the user is enabled to select a modification from the two or more modifications (also referred to as selectable modifications or candidate modifications). For example, the candidate modifications may be displayed to the user in a scrollable list, and the user may click on/select the desired modification.

In some implementations, a user may be enabled to choose a default modification that is made when the user does not specify a modification. Such a default modification, in some implementations, is saved to a profile associated with the user and/or with the device so that the default modification is enabled for the user when using any web application in the web browser. Moreover, the user may save their most recent modification to a buffer (e.g., cache memory) or other storage for application to a subsequent web page.

In some implementations, a modification may take the form of a deemphasis of web page elements that do not satisfy the criterion. For example, a deemphasis can take the form of a lightening or fading of text color, a reversion from bold text to normal text, an undoing of an emphasis, a decrease in the size of font text, and the like.

Query data represents a query, or a request to modify a user interface or web element. The query data in this context includes an identification of data (e.g., web page elements) in a web page to be modified, a criterion for identifying those structured data elements to be modified, and a modification to be performed on the presentation of the web page. In some implementations, the query data is transmitted to a natural language processor for identification of the data, criterion, and modification. For example, a natural language processor may identify the modification in the query data. The natural language processor may then transmit an identifier representing the modification to a processor on which the web browser runs.

A criterion is a condition satisfied by the data to be modified, and not satisfied by the data that is not to be modified. In some implementations, the reverse occurs. In the above-discussed web meeting application example, the criterion is “same manager as me.” This implies that the processing circuitry will identify an external dataset that includes information about the participants' managers and compare each participant's manager with the participant making the query. For example, the processing circuitry may identify, in the external dataset, all of the participants listed in the database having the same manager as the participant. In another example, the processing circuitry may identify all of the participants listed in the database not having the same manager as the participant.

FIG. 1B is a diagram that illustrates an example electronic environment 100 in which the improved techniques of modifying a web page of a browser application described herein may be implemented. The example of a web meeting application has already been discussed. Other example web pages that may be modified as according to the improved techniques include pages directed to activities such as cooking, banking, news sites, watching sporting events, examining statistics, etc. In short, any web that includes structured data elements and semantic markup information may be modified using the improved techniques.

As shown in FIG. 1B, the electronic environment 100 includes a user device 106 and a network 102 through which the user device accesses a browser application from a web page server 105, e.g., a browser application server. The network 102 may take the form of, e.g., a local area network (LAN), wide area network (WAN), the Internet, or a combination thereof. In some examples, the network 102 can be accessed over a wired and/or a wireless communications link. For example, mobile computing devices, such as smartphones can utilize a cellular network to access the network. There may be multiple user devices 106 and web page server 105 in the electronic environment 100.

In some examples, a web page of a browser application is provided as web page server 105 associated with a domain name. An example web site is a collection of web pages formatted in an appropriate machine-readable language, e.g., a markup language such as hypertext markup language (HTML), that can contain text, images, multimedia content, and programming elements, e.g., scripts. The text, images, multimedia content, and programming elements are examples of web page elements. Each web site is maintained by a publisher, e.g., an entity that manages and/or owns the web site. Web page server 105 can be static or dynamic.

In some examples, web page server 105 provides data over the network 102 and is associated with a resource address, e.g., a uniform resource locator (URL). In some examples, web page server 105 can provide a web site, which includes digital content, such as web pages, word processing documents, and portable document format (PDF) documents, images, video, and feed sources, among other appropriate digital content. The web page server 105 can store content, e.g., words, phrases, images and sounds and may include embedded information, e.g., meta information and hyperlinks, and/or embedded instructions, e.g., scripts.

In some examples, a user device 106 is an electronic device that is under control of a user and is capable of requesting and receiving resources from the web page server 105 over the network 102. Example user devices 106 include personal computers, mobile computing devices, e.g., smartphones, wearable devices, smart televisions, and/or tablet computing devices that can send and receive data over the network 102. As used throughout this document, the term mobile computing device (“mobile device”) refers to a user device that is configured to communicate over a mobile communications network. A smartphone, e.g., a phone that is enabled to communicate over the Internet, is an example of a mobile device, as are wearables and other smart devices such as smart speakers. A user device 106 typically includes a user application, e.g., a web browser, to facilitate the sending and receiving of data over the network 102.

In some implementations in which there are multiple user devices in the network 102, each of the multiple user devices is associated with a respective user. In such a case, a modification to a web page initiated by a first user device associated with a first user may be shared with a second user device associated with a second user. For example, at least some or all of the participants of the web meeting shown in FIG. 1A may be able to view the modification to the web page in the manner initiated by one of the participants. Specifically, that participant may select participants with whom to share the web page modification and exclude others from seeing the web page modification. Such a sharing may be done within the same channels as, for example, a chat channel provided in the web meeting application. The ability to share web page modifications is not limited to this one example of a web meeting application and any web page modifications may be shared with any other user device in the network 102.

In some implementations in which there are multiple user devices in the network 102, each of the multiple devices may make modifications to the web page along the lines disclosed herein. As disclosed above, each of the multiple users on the respective user devices may select other users with whom to share the modifications to the web page. The modification data generated by the processor 120 may be transmitted to other user devices in the network 102. In this case, when the modification to the web page is effected within a browser extension, that browser extension running on browsers of the other user devices receives the modification data and modifies the web page according to the received modification data.

As shown in FIG. 1B, the user device 106 includes processing circuitry 120. The processing circuitry 120 is configured to run the web browser and display browser windows within a user interface in a display of the user device 106. The user interface 111 is also configured to receive user queries and process the received user queries to identify a web element to be modified, the structured data elements identifying the data in the web element that is to be modified, and a modification to be applied. The processing circuitry may further be configured to identify an external dataset (e.g., external dataset 122 and/or from external server 121) through which the criterion is evaluated, and web element data selected for modification. Further details concerning the processing circuitry 120 are discussed with regard to FIG. 2.

As shown in FIG. 1B, the user device 106, via processing circuitry 120, displays a user interface 111 of a web page in a web browser. In the example of FIG. 1B, the user interface 111 is shown in a single browser tab displaying a web page with various web page elements 112, 113, 114, although in some implementations, other web pages may be viewed by clicking on a tab at the top of the user interface 111. Also shown in FIG. 1B is the user interface 111 as a separate entity from the processing circuitry 120. While this is one possible configuration, in some implementations shown in FIG. 2, elements of the user interface 111 are integrated into the processing circuitry 120.

The web page elements 112, 113, 114 are objects displayed by the web browser in the presentation of the web page 111. The web page elements 112, 113, 114 each include data displayed to the user as discussed with respect to FIG. 1A and in other examples. For example, a restaurant ordering application or cooking site may display ingredients of a dish offered in web page element 112, a description of the dish offered in web element 113, and/or instructions for preparing the dish in web page element 114.

As shown in FIG. 1B, each of the web page elements 112, 113, 114 includes respective structured data elements 115, 116, 117. The structured data elements 115 function as descriptors of the data. For example, a table or list is a structured data element that is arranged for easier viewing and sorting. For example, in the restaurant ordering application, the ingredients listed in web page element 112 may include flour, sugar, eggs, water, milk, baking powder, salt, vanilla, chocolate chips, and bananas.

In some implementations, the web page elements 112, 113, 114 are associated with a document model (e.g., document object model) that includes a set of nodes representing the structured data elements 115, 116, 117. In the example above, the items may be list elements, e.g., identified by the <li> HTML tag. In the example above, the items may be in a separate table row, e.g., with each item being in a column labeled “ingredient” and appearing with other columns, such as measurement type, measurement amount, and/or calories. In the example above, the items may have semantic markup, e.g., a metadata tag indicating each item is an ingredient in a recipe.

In an example, a user may submit a query 108, “mark ingredients in my shopping list that are on sale at a grocery store close to me.” The processing circuitry 120 performs a natural language processing operation on the query and, in conjunction with semantic data on the web page, determines that the intent of the user is to access grocery information for the user, e.g., associate with a user profile or an account of the user. It is noted that some shopping list data as described here may be private and is not to be shared with the public. Accordingly, the processing circuitry 120 should be able to modify the user interface without sending private data, or any other data, to the web page server 105, for example.

Moreover, the criterion the user has specified in the query 108 is that an ingredient identifier listed in the web page element 112 matches a food identifier in a grocery store database identifying that food as being on sale. Accordingly, the processing circuitry accesses the structured data elements 115 to obtain the ingredient identifiers of the structured data elements 115 and compares these food identifiers with the food identifiers in the grocery database. The processing circuitry identifies the matches between the food identifiers and the ingredient identifiers, as shown in the example of FIG. 1B as the identified structured data element 118.

The query data also specifies a particular modification. The modification may be specific, such as “highlight” or “turn blue”. The modification may be general, i.e., “mark” in the example query 108 or “show me”. The system may include a plurality of predefined modification identifiers, which correspond to the text string in the query data. (e.g., “highlight,” “italicize,” “bold,” “underline,” etc.). These predefined modifications may include a template with a fixed portion and a variable portion, e.g., “turn *” with the variable portion matching (corresponding to) what follows the fixed portion. The variable portion may represent a set of predefined values, such as colors. Thus, “turn red” or “make blue” may be modification identifiers that correspond with a predefined modification. Some predefined terms in the query may be translated to a modification identifier. For example, the processing circuitry 120 may recognize “mark” in a query as a non-specific modification request, and translate “mark” (the non-specific modification request) to “highlight” (a modification identifier). This translation may be determined by randomly selecting the modification identifier from among the predefined modification identifiers. This translation may be determined by selecting a default modification identifier. This translation may be determined by rules or by a machine-learned classifier that performs a machine-learning-based classification operation to identify “mark” as being most likely to refer to highlighting. The modification identifier of highlighting may be associated with instructions for applying a background color mark-up tag to the web page element(s) that satisfy the criterion. Accordingly, the processing circuitry 120 transmits instructions in the form of modification data 109 to highlight the structured data elements 115 for which the ingredient identifier matches a food identifier in the grocery database. Now the user interface 111 shows the user which ingredients are on sale at a local grocery store.

In some implementations, the processing circuitry 120 obtains the external dataset from an external dataset available to the user device 106 and not on a public network. For example, the external dataset 122 may be local storage on the user device 106. Alternatively, the external dataset 122 may be an external disk drive directly connected to the user device 106 or over a wireless LAN.

In some implementations, the processing circuitry 120 obtains the external dataset from an external server 121 over a network 103. In some implementations, the network 103 is not distinct from the network 102. In some implementations, the network 103 is separate from the network 102. In some implementations, the network 103 includes a virtual private network (VPN) for accessing private data.

FIG. 2 is a diagram that illustrates the example processing circuitry 120 (FIG. 1B) in which the above-described technical solution may be implemented. The processing circuitry 120 is configured to.

The processing circuitry 120 includes a network interface 222, one or more processing units 224, memory 226, and a display interface 228. The network interface 222 includes, for example, Ethernet adaptors, Token Ring adaptors, and the like, for converting electronic and/or optical signals received from the network to electronic form for use by the processing circuitry 120. The set of processing units 224 include one or more processing chips and/or assemblies. The memory 226 includes both volatile memory (e.g., RAM) and non-volatile (non-transitory) memory, such as one or more ROMs, disk drives, solid state drives, and the like. The set of processing units 224 and the memory 226 together form controlling circuitry, which is configured and arranged to carry out various methods and functions as described herein. The display interface 228 is configured to provide data to a display device for rendering and display to a user.

In some implementations, one or more of the components of the processing circuitry 120 can be, or can include processors (e.g., processing units 224) configured to process instructions stored in the memory 226. Examples of such instructions as depicted in FIG. 2 include a query manager 230, a web browser manager 240, an external dataset manager 250, and a web page element modification manager 260. Further, as illustrated in FIG. 2, the memory 226 is configured to store various data, which is described with respect to the respective managers that use such data.

The query manager 230 is configured to receive query data 231. In some implementations, the query manager 230 receives the query data 231 over the network interface 222, i.e., over a network. In some implementations, the query manager 230 receives the query data 231 directly as user input, e.g., from user device 106. As shown in FIG. 2, the query manager 230 includes a natural language processing (NLP) manager 232.

The query data 231 represents a query (i.e., a request) to modify the user interface web page elements according to a criterion. In some implementations, the query data 231 takes the form of a string of characters. In some implementations, the query data 231 takes an alternative form, e.g., a graphic, an image, an audio clip, a video, etc. In some implementations, the query data 231 is written in a form appropriate for natural language processing.

The NLP manager 232 is configured to process the query data 231 using a natural language processing algorithm to produce NLP data 233. The NLP algorithm works primarily with syntax (i.e., structure) of the query represented by the query data 231 and semantics (i.e., meaning) as represented by semantic data, e.g., semantic data 244. On the syntax side, the NLP algorithm may be configured to lemmatize words and relate them to their basic forms, e.g., part-of-speech analysis. In some implementations, the NLP algorithm includes breaking apart sentences, inducing grammatical structures, and segmenting words. On the semantics side, the NLP algorithm may perform entity and entity attribute analysis and recognition (including entity names and synonyms).

The NLP data 233 represents output of running the NLP algorithm of the NLP manager 232. The NLP data 233 is in a form that is interpretable by the processing circuitry 120 for identifying structured data elements from which the user interface 111 (FIG. 1B) is to be modified as well as the modification of the user interface 111 based on the identified structured data elements. As shown in FIG. 2, the NLP data 233 includes criterion data 234, structured data element identifier data 235, modification data 236, and/or external dataset identifier data 237; this data represents output from the natural language processing algorithm.

The criterion data 234 represents a criterion by which the structured data elements from which the user interface 111 is to be modified are identified. For example, for the request “show me the participants having the same manager as me,” the NLP manager 232 may deduce that the criterion represented by the criterion data 234 identifies participant names in an external dataset relevant to the request as having the same manager as the user. In another example, for the request “mark ingredients that are on sale at a nearby grocery store,” the NLP manager 232 may deduce that the criterion represented by the criterion data 234 identifies food identifiers in a grocery database which are identified as being on sale. Generally, the criterion data 234 indicates an aspect of the external dataset that is to be compared to a field in the structured data elements.

The structured data element 235 represents references to structured data elements (e.g., structured data elements 115 of FIG. 1B) of web page elements (e.g., web page element 112) indicated in the criterion. For example, in FIG. 1A the structured data element identifier data 235 represents user identifiers “user1,” “user2,” . . . , “user12.” The query manager 230 is then further configured to match the structured data element identifier data 235 with corresponding data in the external dataset (e.g., external dataset data 251). For example, the query manager 230 compares the user identifiers of structured data element identifier data 235 with user identifiers in a human resources database that provide manager information for each identifier. Along with the criterion data 234, the query manager 230 then identifiers those structured data element identifiers satisfying the criterion, i.e., user identifiers having a specific manager. Further detail about structured data elements is discussed with regard to FIG. 3.

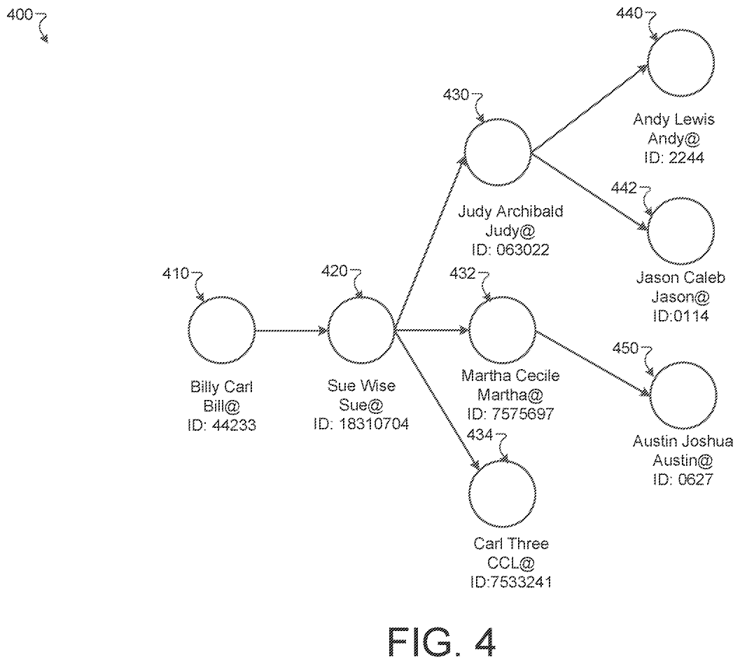

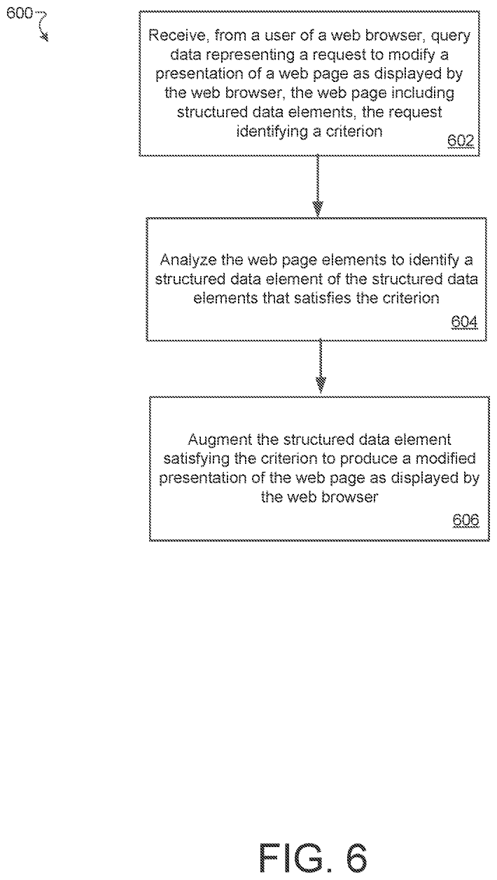

In some implementations, the query manager 230 identifies structured data elements by identifying table elements, list elements, or semantic markup elements. For example, HTML table elements that may be identified include tags such as <tr> (define a row of a table), <th> (define a header), and <td> (define a cell in the table). HTML list elements that may be identified include tags such as <ul> for an unordered (bulleted) list, <ol> for an ordered list, and <dl> (definition list). HTML semantic markup items defining semantic markup information include descriptors of what each element represents. For example, an HTML tag <div itemtype=“http://schema.org/Restaurant”><spanproperty=“rating”>4</span><span property=“telephone”>867-5309</span></div> informs a natural language processor that a value of a first field in a structured data element represents a restaurant as defined in the schema.org hierarchy. The restaurant has a rating value of 4 and a telephone number of 867-5309. Accordingly, the semantic markup information places the rating and phone number in the context of a restaurant. Once the structured data elements are identified via these table elements, list elements, or semantic markup elements, the query manager 230 compares the structured data elements to the criterion as described with regard to FIGS. 4 and 6.

FIG. 3 is a diagram that illustrates example web elements and structured data elements in a web page 300. In this context, the web page 300 represents a web meeting application as in examples above. The user interface of the web page 300 in this case may resemble the user interface 111 shown in FIG. 1A. FIG. 3 represents a hierarchal arrangement of the web meeting application. In some implementations, FIG. 3 represents a simplified document object model.

The web page 300 has a top-level page 302 that represents the web application as a whole and is displayed in a user interface (i.e., user interface 111). In the case shown in FIG. 3, the web application is a web meeting. This top-level page 302 has two web elements: a first web element that displays a chat section 304 and a second web element that displays a participant list 306.

The chat section 304 is configured to enable the participants to send private or public messages to other participants during a web meeting. As shown in FIG. 3, the chat section 304 includes a message list 308 representing the public and/or private messages sent between the meeting participants.

The message list 308 includes structured data elements 310(1) and 310(2), each representing data (e.g., metadata) describing each message. As shown in FIG. 3, the structured data element 310(1) includes fields having a message identifier of “Message 1,” a sender identifier of “Judy@,” and a representation of the message body of “Hi, Andy.” It is noted that the representation of the message body may contain the entire message, a portion of the message, or the first few words in the message. The structured data element 310(2) has field values of “Message 2,” “Jason@,” and “Let's meet in Austin,” respectively.

The participant list 306 is configured to include all participants in the web meeting. In some implementations, the participant list 306 may change in real time according to which participants enter or leave the web meeting while the web meeting is being conducted. In some implementations, the participant list 306 is static. The participant list 306 includes structured data elements 312(1), 312(2), 312(3), and 312(4), each representing data (e.g., metadata) describing each participant. As shown in FIG. 3, the structured data element 312(1) includes fields having a first name identifier of “Judy,” a last name identifier of “Archibald,” and an email address identifier of “Judy@” (matching the sender identifier in structured data element 310(1)). The structured data element 312(2) includes a first name identifier of “Andy,” a last name identifier of “Lewis,” and an email address identifier of “Andy@.” The structured data element 312(3) includes a first name identifier of “Jason,” a last name identifier of “Caleb,” and an email address identifier of “Jason@.” The structured data element 312(4) includes a first name identifier of “Austin,” a last name identifier of “Joshua,” and an email address identifier of “Austin@.” In some implementations, the “Austin” in the message body of structured data element 310(2) would be rendered as different from the “Austin: in the first name identifier of structured data element 312(4) by the NLP algorithm, as the context of the former identifies a location, and the context of the latter identifies a person.

It is noted that the structured data elements of a web page element, when a document model with which the web page elements are associated is a tree structure, are represented by a set of nodes of the tree structure. That is, the document model associated with a web page element describes a relationship of the structured data elements with each other.

Returning to FIG. 2, the modification data 236 represents the modification to be applied to the structured data element identifiers in a web element of the user interface satisfying the criterion. For example, the NLP algorithm processes the above query to identify a modification based on the word “show” and to identify semantic information, e.g., semantic data 244. In some implementations, the query manager 230 interprets this modification to indicate an emphasis operation on the selected structured data element identifiers. In some implementations, the modification is selected from a finite, specified list of modifications.

The external dataset identifier data 237 represents an external dataset (e.g., external dataset 122 of FIG. 1B) identified in the query. For example, the NLP algorithm processes the above query to identify an external dataset based on the word “manager” and semantic information, e.g., semantic data 244. Based on the semantic data, the NLP algorithm identifies the word “manager” as having relevance to a human resources database. In this case, the external dataset identifier data 237 includes data representing an identifier of the human resources database.

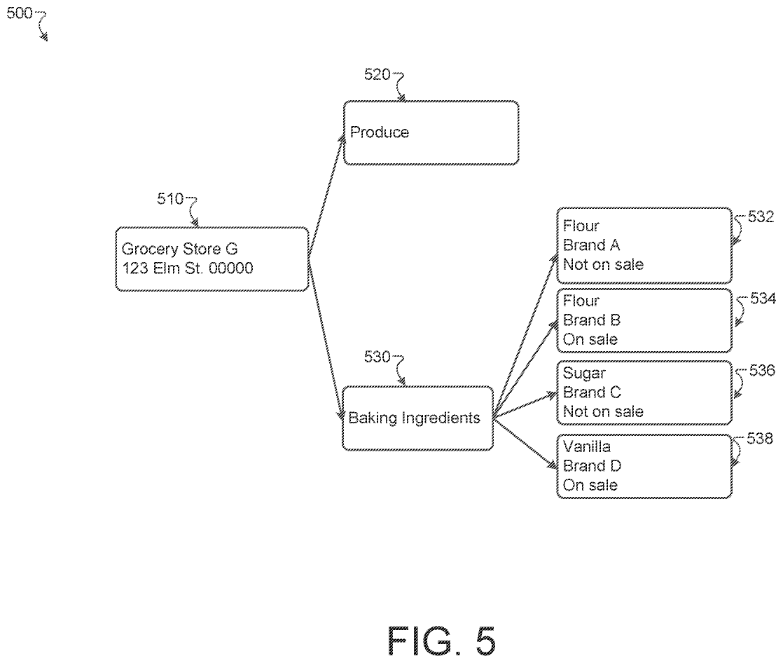

In some implementations, for the above example, the human resources database is stored locally and the identifier provides a location of the human resources database in storage. In some implementations, the human resources database is accessed over a network (e.g., network 103) at an external server (e.g., external server 121). In some implementations, the human resources database is private and may only be accessed from the external server using various data protection schemes (e.g., passwords, two-way authentication, knowledge-based authentication, or the like). Further detail regarding an external dataset is discussed with respect to FIGS. 4 and 5.

In some implementations, the external dataset is associated with a profile of the user. In some implementations, the profile is associated with a user name/password. In some implementations, the profile of the user is stored with web browser information and may be accessed through web browser preferences. For example, a profile of the user stored may include a browsing history, a set of bookmarks, browser themes, avatars, security options, and the like. Based on such a profile, the external dataset manager 250 may select a particular external dataset. For example, if a user has a bookmark pointing to a grocery store web site, the external dataset manager 250 may choose to extract data from that website.

In some implementations, the external dataset is a search result returned form a search engine index, which can search a document repository and/or knowledge graph (entity/fact repository). In some implementations, the processing circuitry may submit a query (e.g., second query or search engine query) to the search engine that includes terms and/or phrases from the request and/or from the structured data elements. For example, a user looking at a web page with a recipe may provide a request to “highlight ingredients with gluten”. After identifying structured elements for ingredients in the web page elements, the system can submit a query to the search engine for each element, e.g., a query of ‘milk has gluten’, ‘cornmeal has gluten’, etc. The system may receive the search results and parse the result to determine whether that ingredient should be modified (highlighted). Some search results include a onebox or short answer result to such factual queries. Accordingly, an external dataset may be selected based on its presence in a search engine index.

In some implementations, the external dataset includes data originating from another open browser tab. Such data is technically external data, as it is external to the browser tab of interest.

FIG. 4 is a diagram illustrating an example external dataset 400 for modifying a web element of a web page. The example external dataset 400 represents an organizational chart stored in a human resources database to which a user has access. For example, an organization to which the user belongs (e.g., employee in a firm or corporation) may send the user the organization chart in a form readable by the query manager 230 and/or an external dataset manager 250.

The example external dataset 400 is represented in FIG. 4 as a tree in which an arrow connector represents a reporting relationship. The reference numerals shown in FIG. 4 are arranged according to manager. Accordingly, the member represented by database element 410 is the manager of the member represented by database element 420. The member represented by database element 420 is the manager of the members represented by database elements 430, 432, and 434. The member represented by database element 430 is the manager of the members represented by database element 440 and database element 442. The member represented by database element 432 is the manager of the member represented by the database element 450.

Consider the case in which the member represented by database element 432 is the user forming the above-discussed query or request, “show the participants having the same manager as me.” The query manager 230 has determined via the NLP algorithm that the query intent indicated the human resource database as the external dataset. The query manager 230 determines the participants in the participant list reporting to the same participant as the member represented by database element 432. As shown in FIG. 4, those members are represented in the external dataset 400 as database element 430 and database element 434. The members represented by database elements 430 and 434 may be found by matching identifiers from the structured data elements 312(1-4) to identifiers in the external dataset 400. For example, the query manager 230 may determine that a value of an email field in the structured data elements 312(1-4) corresponds to a value of an email addresses in the external dataset 400. From those matches, the query manager 230 may locate those structured data elements that are pointed to by the same structured data element pointed to by database element 420. Accordingly, the query manager 230 returns modification instructions referencing the email identifiers of database element 430 and database element 434.

FIG. 5 is a diagram illustrating an example external dataset 500 for modifying a web element of a web page. In this case, the external dataset is relevant to an ingredient list in a database storing information about grocery items in a grocery store and has database elements shown for a user. An example of a use for external dataset 500 in this context includes queries from a cooking application such as “highlight the ingredients that are on sale at a grocery store close to me.”

As shown in FIG. 5, the database elements shown as arranged in a tree format in the external dataset 500. In contrast to the external dataset 400 shown in FIG. 4, the database elements have different information at each level. At the top level with database element 510 is information identifying the local grocery store; the fields include a store identifier (“Grocery Store G”) and an address (“123 Main St. 00000”). It is noted that the address may be in any format and is not limited to the street and ZIP code as show in in FIG. 5.

As shown in FIG. 5, the database element 510 is a parent database element to database elements 520 and 530. database elements 520 and 530 represent a departments of the grocery store. The database element 520 has a field value “Produce.” The database element 530 has a field value “Baking Ingredients,” and the data are arranged as database elements 532, 534, 536, and 538. The database elements 532, 534, 536, and 538 represent various products sold in the “Baking Ingredients” department. The database elements 532 represents the ingredient flour, with additional fields identifying the flour as having a brand “Brand A” and specifying that it is not on sale. Database element 534 has field values “Flour,” “Brand B,” and “On sale”; database element 536 has field values “Sugar,” “Brand C,” and “Not on sale”; database element 538 has field values “Vanilla,” “Brand D,” and “On sale.”

It is noted that the external datasets 400 and 500 discussed with regard to FIGS. 4 and 5, respectively may contain private data. For example, the organizational chart of external dataset 400 may be confidential data to an organization. Accordingly, such private data used for the user interface modification as described herein must not be shared with other entities, i.e., the web server providing the web meeting application or the restaurant ordering application. Accordingly, the external dataset manager 250 is configured to prevent the transmission of private data to other entities, electronic or otherwise.

In some implementations, the modification of a web page, web page elements, or structured data elements are not applied based on an identification of an external dataset such as external datasets 400 and 500. In such an implementation, the modification is based on data local to the user device 106 (FIG. 1B). For example, the processor 120 (FIG. 1B) in this case may be configured to determine that the criterion is satisfied using the elements of the displayed web page. In other words, if the processor 120 can determine that the criterion is satisfied by inspecting the structured elements of the web page, the requested modification can be applied without reference to an external data set. In one example, the web page may be information in search result page based on a user query. The processor 120 may be able to identify a search result (or results) that satisfy the criterion and apply the modification to that result (or results). For example, if the web page is a search result for “restaurants near me” the user may submit the query “highlight inexpensive restaurants” and the processor 120 may identify web page elements representing the cost associated with each search result (e.g., from a label in a DIV or SPAN tag) and use this information to determine which search results to apply the highlight to. In another example, the external data set may be the results of a query to a search engine. For example, the processor 120 may obtain data from a search engine result page corresponding to the element and use the data from the search engine result page to identify structured data element(s) satisfying the criterion. For example, rather than accessing external dataset 500, a user device may generate such data from a search query for local grocery stores having the ingredients and whether such ingredients are on sale. In some implementations, the processor 120 may store the search result in local storage, i.e., a disk connected to the user device directly or over a wireless network. In some implementations, the processor 120 may assign metadata to the search result based on the search query. In some implementations, the metadata includes markup language, e.g., HTML DIV or SPAN tags derived from the search query. Based on the markup language in the metadata, the processor 120 may determine that the criterion includes an element corresponding to the data.

Returning to FIG. 2, the web browser manager 240 is configured to run the web browser whose user interface (e.g., user interface 111) undergoes modification according to a user query. Recall that a web browser is application software running on processing circuitry (e.g., processing circuitry 120) for accessing web pages. When a user requests a web page from a website, the web browser retrieves web browser data 241 from a web server and displays the content in a page in a browser window on the user's device in response to a resource locator input by the user. A web browser may display multiple web pages within a single user interface; each such web page is activated using a tab at, e.g., the top of the user interface. A user of the web browser may activate a different web page by clicking on its tab on the user interface.

The web browser data 241 represents the data used and/or displayed by the web browser that may be accessed for the purpose of modifying the user interface of the web browser. As shown in FIG. 2, the web browser data includes web page element data 242(1 . . . M), where M is the number of web page elements managed by the web browser and displayed on a web page. The web browser data also includes semantic data 244.

Each of the web page elements 242(1 . . . M), e.g., 242(1), is an object displayed by a web browser in a user interface in a browser window, based on data received from a web page server (e.g., web page server 105). For example, in the above-discussed web meeting application, the web page elements 150 and 160 contain visual information about the meeting participants and participant names. In a browser application, some web page elements include application data (e.g., meeting participant identifiers, avatars, and photos) and other forms of data including semantic information (e.g., first name, last name, email address, etc.). In some implementations, the web page elements 150 and 160 are received from the web page server in the form of data and instructions for displaying.

As show in FIG. 2, each web page element, e.g., web page element 242(1), includes structured data element data 243(1,1 . . . N_1), where N_1 is the number of structured data elements in the web page element 242(1). (N_k is the number of structured data elements in web page element 242(1,k).) Each of the structured data elements, e.g., structured data element data 243(1,1) is a data object stored in a data structure and organized according to a data model. In some implementations, structured data elements conform to a tabular format with relationship between different rows and columns. In this way, different rows and columns may be sorted or searched according to a query. For example, FIG. 3 shows different structured data elements that may be stored in a web page and who field values may be compared to field values of external datasets.

The semantic data 244 represents semantic information embedded in the web page including semantic metadata. To enable the encoding of semantic information with the data, technologies such as Resource Description Framework (RDF) and Web Ontology Language (OWL) are used. These technologies are used to formally represent metadata. For example, ontology can describe concepts, relationships between entities, and categories of things. These embedded semantics offer significant advantages such as reasoning over data and operating with heterogeneous data sources.

For example, in the web meeting application example above, the data representing the participant list (e.g., Participant List 306 of FIG. 3) in the meeting can include metadata to identify that this is a list of users, and all of the data in the table can be clearly identified, such as First Name, Last Name, LDAP/Email Address, etc. This enables the improved techniques to understand the data in the web page because it is in a machine-readable format through semantic metadata of semantic data 244. This also allows the improved techniques to connect that data in one web page with other data, which enables the modification of user interface, e.g., user interface 111.

The external dataset manager 250 is configured to identify and obtain external dataset data 251 from a variety of sources. In some implementations, the external dataset manager 250, before any user query is received by the query manager 230, is configured to access sources of information from local sources, i.e., attached or internal hard drive, or remote sources via the network interface 222. In some implementations, the external dataset manager 250 assigns unique identifiers to each external dataset so accessed and obtained.

In some implementations, the external dataset manager 250 is configured to access external dataset data 251 in response to the query manager 230 receiving query data, e.g., query 108 of FIG. 1B. For example, in the web meeting application example above, in response to the query manager 230 receiving and processing a query via a NLP algorithm using semantic data 244, the external dataset manager 250 is configured to obtain data via remote sources via the network interface 222 based on the semantic data 244.

The external dataset data 251 includes information relevant to user queries, for example the organizational chart in FIG. 4 or the grocery data in FIG. 5, each modeled as tree structures. As show in in FIG. 2, the external dataset data 251 can include public data 252 and private data 253. Public data 252 is data that may be seen by other users. Private data 253 is data that can only be seen by authorized individuals or groups. In some implementations, the external dataset manager 250 is configured to prevent private data 253 from being transmitted to a remote server hosting the browser application.

The web page element modification manager 260 is configured to perform the modifications to the web page elements of a web page according to web page element modification data 271, as determined from query data received by the query manager 230. In some implementations, the web page element modification manager 260 is implemented as part of the browser or as a browser extension capable to modify the context of webpages as they are displayed. In some implementations, the web page element modification manager 260 may alter the appearance of pixels displaying the web page elements to be modified. In some implementations, the web page element modification manager 260 may generate other effects for the web page elements, e.g., increasing brightness of pixels in a region to be modified or generating animation effects such as blinking or simulating waves over the region. In some implementations, the web page element modification manager 260 modify the web page such that web page elements are re-sorted, e.g., reordering or rearranging table rows or list elements. In some implementations, the web page element modification manager 260 removes objects from the display as a modification.

In some implementations, the page element modification manager 260 selects a particular modification based on the query from a library or repository of modifications, as represented by library data 272 in FIG. 2. Such a library may include instructions for applying the modification to the web page. This may include the mark up tags or labels that correspond to the particular modification. The library (repository) can also improve the performance of the modification when the query is unclear about the modification. For example, if a query states “show me the participants having the same manager as me,” then the processing circuitry may select a modification at random from the library. In some implementations, the improved techniques include a default modification in case the query renders the modification as indeterminate. In some implementations, the library data 272 includes a descriptor of the modification in terms of markup language. In some implementations, the library data 272 includes instructions for applying the operation to a web element or user interface. For example, if the modification of a web page element is determined to be an italicize operation from the library, the web page element modification manager 260 may add a markup (e.g., HTML) tag or label to the web page to modify the element. In some implementations, the modification may be applied to several related web page elements. For example, if a cell in a table row satisfies the criterion the entire row may have the modification applied. Likewise, an individual search result may be modified when one item of information in the result satisfies the criterion. In some implementations, the structured element that is determined to satisfy the criterion is modified.

The components (e.g., modules, processing units 224) of the user device 106 can be configured to operate based on one or more platforms (e.g., one or more similar or different platforms) that can include one or more types of hardware, software, firmware, operating systems, runtime libraries, and/or so forth. In some implementations, the components of the processing circuitry 120 can be configured to operate within a cluster of devices (e.g., a server farm). In such an implementation, the functionality and processing of the components of the processing circuitry 120 can be distributed to several devices of the cluster of devices.

The components of the processing circuitry 120 can be, or can include, any type of hardware and/or software configured to process attributes. In some implementations, one or more portions of the components shown in the components of the processing circuitry 120 in FIG. 2 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 120 can be, or can include, a software module configured for execution by at least one processor (not shown). In some implementations, the functionality of the components can be included in different modules and/or different components than those shown in FIG. 2, including combining functionality illustrated as two components into a single component.

Although not shown, in some implementations, the components of the processing circuitry 120 (or portions thereof) can be configured to operate within, for example, a data center (e.g., a cloud computing environment), a computer system, one or more server/host devices, and/or so forth. In some implementations, the components of the processing circuitry 120 (or portions thereof) can be configured to operate within a network. Thus, the components of the processing circuitry 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 120 can be, or can include, processors configured to process instructions stored in a memory. For example, a query manager 230 (and/or a portion thereof), a web browser manager 240 (and/or a portion thereof), an external dataset manager 250 (and/or a portion thereof), and a web page element manager 260 (and/or a portion thereof).

In some implementations, the memory 226 can be any type of memory such as a random-access memory, a disk drive memory, flash memory, and/or so forth. In some implementations, the memory 226 can be implemented as more than one memory component (e.g., more than one RAM component or disk drive memory) associated with the components of the processing circuitry 120. In some implementations, the memory 226 can be a database memory. In some implementations, the memory 226 can be, or can include, a non-local memory. For example, the memory 226 can be, or can include, a memory shared by multiple devices (not shown). In some implementations, the memory 226 can be associated with a server device (not shown) within a network and configured to serve the components of the processing circuitry 120. As illustrated in FIG. 2, the memory 226 is configured to store various data, including query data 231, web browser data 241, and external dataset data 251.

FIG. 6 is a flow chart depicting an example method 600 according to the above-described improved techniques for producing a modified user interface displayed by a web browser based on a query from a user. The method 600 may be performed by software constructs described in connection with FIG. 2, which reside in memory 226 of the processing circuitry 120 and are run by the set of processing units 224.

At 602, the query manager 230 receives, from a user of a web browser, query data (e.g., query 108) representing a request to modify a presentation of a web page (e.g., web page elements 112) as displayed by the web browser in a user interface (e.g., user interface 111), the web page elements including structured data elements (e.g., structured data elements 115), the request identifying a criterion (e.g., criterion data 234). For example, the query manager 230 may receive a user query, “highlight the ingredients that are on sale at a grocery store close to me.” Using a NLP algorithm, the query manager 230 determines that the user intends to look at grocery price data and identify items in the ingredient list that are on sale.

At 604, the query manager 230 analyzes the web page to identify a structured data element (e.g., structured data element 118) of the structured data elements that satisfies the criterion. For example, the criterion determined from the query in the example above is “ingredient identifiers corresponding to (matching) food identifiers in a grocery list of food items that are on sale.” The query manager 230 then identifies and accesses an external dataset managed by the external dataset manager 250 and performs the comparison. When there is an ingredient identifier matching a food identifier of the grocery list, the query manager 230 identifies the structured data element having that ingredient identifier as a field value. The query manager 230, after applying the NLP and semantic markup info to the query, identifies the criterion as “Product identifiers==foodIdentifiers AND foodIdentifiers.isOnSale=TRUE.” The NLP identifies this criterion as such using semantic markup information such as <div itemscope itemtype=“https://schema.org/SomeProducts”itemid=“#product”>.”

At 606, the web page modification manager 260 applies a modification (e.g., modification data 236) to the structured data element satisfying the criterion to produce a modified presentation of the web page (e.g., modified web page element 160) as displayed by the web browser. For example, once the structured data element satisfying the criterion and the modification have been identified, the web page element modification manager 260 performs the prescribed modification (e.g., emphasis operation) on a displayed representation of the structured data element, e.g., highlighting, checking, bolding, italicizing, blinking, reordering, and the like.

In some implementations, the page modification manager 260 applies modifications selected from a library of modifications. For example, such a library may have available for selection modifications such as those listed above: highlighting, checking, bolding, italicizing, blinking, and the like.

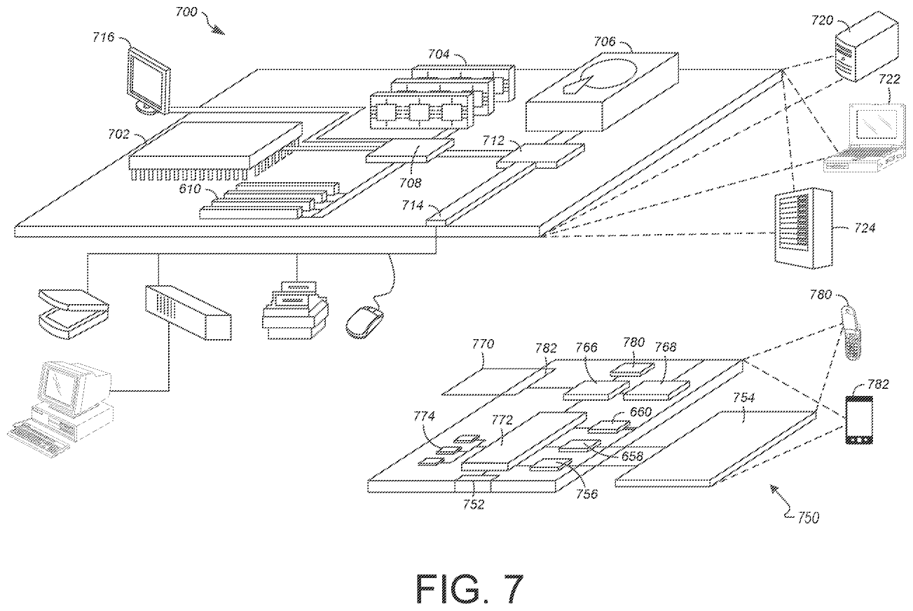

FIG. 7 illustrates an example of a generic computer device 700 and a generic mobile computer device 750, which may be used with the techniques described here. Computer device 700 is one example configuration of user device 106 of FIG. 1A and/or processing circuitry 120 of FIG. 2.

As shown in FIG. 7, computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be examples only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 504 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 506, or memory on processor 702.

The high speed controller 708 manages bandwidth-intensive operations for the computing device 700, while the low speed controller 712 manages lower bandwidth-intensive operations. Such allocation of functions are examples only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 760 may be provided in communication with processor 752, so as to enable near area communication of device 750 with other devices. External interface 760 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750 or may also store applications or other information for device 750. Specifically, expansion memory 774 may include instructions to carry out or supplement the processes described above and may include secure information also. Thus, for example, expansion memory 774 may be provided as a security module for device 750 and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

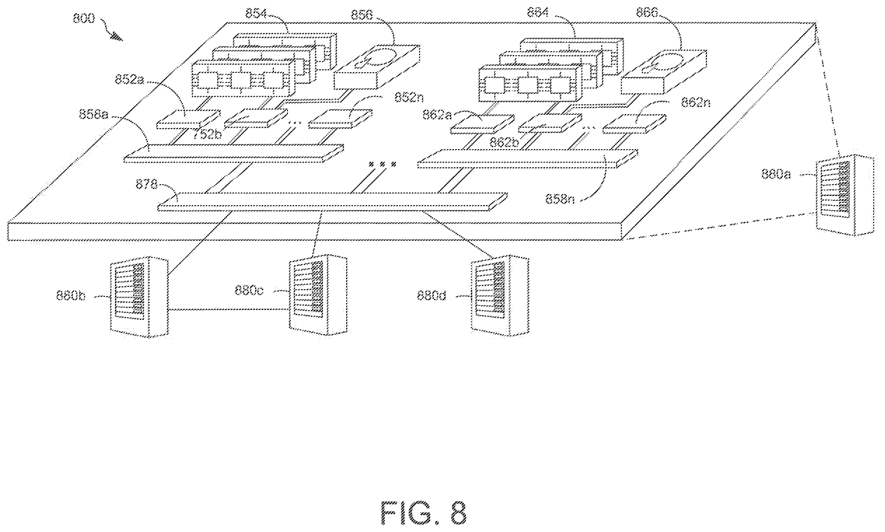

FIG. 8 shows an example of a generic computer device 800, which may be processing circuitry 120 of FIG. 2, which may be used with the techniques described here. Computing device 800 is intended to represent various example forms of large-scale data processing devices, such as servers, blade servers, datacenters, mainframes, and other large-scale computing devices. Computing device 800 may be a distributed system having multiple processors, possibly including network attached storage nodes, that are interconnected by one or more communication networks. The components shown here, their connections and relationships, and their functions, are meant to be examples only, and are not meant to limit implementations of the inventions described and/or claimed in this document.

Distributed computing system 800 may include any number of computing devices 880. Computing devices 880 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 880a includes multiple racks 858a-858n. Each rack may include one or more processors, such as processors 852a-852n and 862a-862n. The processors may include data processors, network attached storage devices, and other computer controlled devices. In some implementations, one processor may operate as a master processor and control the scheduling and data distribution tasks. Processors may be interconnected through one or more rack switches 858, and one or more racks may be connected through switch 878. Switch 878 may handle communications between multiple connected computing devices 800.

Each rack may include memory, such as memory 854 and memory 864, and storage, such as 856 and 866. Storage 856 and 866 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 856 or 866 may be shared between multiple processors, multiple racks, or multiple computing devices and may include a computer-readable medium storing instructions executable by one or more of the processors. Memory 854 and 864 may include, e.g., volatile memory unit or units, a non-volatile memory unit or units, and/or other forms of computer-readable media, such as a magnetic or optical disks, flash memory, cache, Random Access Memory (RAM), Read Only Memory (ROM), and combinations thereof. Memory, such as memory 854 may also be shared between processors 852a-852n. Data structures, such as an index, may be stored, for example, across storage 856 and memory 854. Computing device 800 may include other components not shown, such as controllers, buses, input/output devices, communications modules, etc.

An entire system, such as electronic environment 100, may be made up of multiple computing devices 800 communicating with each other. For example, device 880a may communicate with devices 880b, 880c, and 880d, and these may collectively be known as electronic environment 100. As another example, processing circuitry 120 of FIG. 2 may include one or more computing devices 800. Some of the computing devices may be located geographically close to each other, and others may be located geographically distant. The layout of system 800 is an example only and the system may take on other layouts or configurations.

In some implementations, the request includes a natural language query and the structured data elements of the web page elements include semantic markup information; in such implementations, analyzing the web page elements includes determining a term in the natural language query based on the semantic markup information.

In some implementations, the modification is obtained from a library of modifications available to the user. In some implementations, the library of modifications includes a highlighting modification.

In some implementations, the improved techniques include determining that the criterion includes an element corresponding to information in an external dataset; obtaining data from the external dataset that corresponds to the element; and using the data from the external dataset to identify the structured data element that satisfies the criterion. In some implementations, the external dataset is obtained from a server different from a server transmitting the web page elements to the web browser. In some implementations, the external dataset is associated with a profile of the user. In some implementations, the external dataset is associated with a search engine index. In some implementations, the external dataset includes an open browser tab in the web browser.

In some implementations, the external dataset includes private data originating from a private data resource. In some implementations, the web page elements are received from a web page server, and the improved techniques include preventing the private data from being transmitted to the web page server.

In some implementations, analyzing the web page elements includes identifying the structured data elements from the web page elements by identifying table elements, list elements, semantic markup elements, or accessibility data; and comparing the structured data elements to the criterion. In some implementations, the request further identifies an emphasis operation, the modified user interface applying the emphasis operation to the structured data element satisfying the criterion. In some implementations, the emphasis operation maps to one operation of a plurality of predefined emphasis operations. In some implementations, the web page elements include a table with table elements and the structured data element satisfying the criterion is in a region of the table. In such implementations, producing the modified user interface further includes changing an appearance of the region. In some implementations, the web page elements are associated with a document model that includes a set of nodes representing the structured data elements of the web page elements. In such implementations, modifying the structured data element includes editing a node of the document model represented by the structured data element that satisfies the criterion to change an appearance of the structured data element.

In some implementations, obtaining data from the external dataset that corresponds to the element includes identifying a uniform resource locator (URL) associated with the element; and accessing the data at a web resource determined from the URL.

In some implementations, the user belongs to an organization; and obtaining data from the external dataset that corresponds to the element includes receiving the data from a resource associated with the organization at a point in time prior to receiving the query data

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-based method comprising:
receiving, from a user of a web browser, query data representing a request to modify a presentation of a web page as displayed by the web browser, the web page including structured data elements, the request identifying a criterion;
analyzing the web page to identify a structured data element of the structured data elements that satisfies the criterion; and
applying a modification to the structured data element satisfying the criterion to produce a modified presentation of the web page as displayed by the web browser.

2. The computer-based method as in claim 1, wherein the request includes a natural language query and the structured data elements of the web page include semantic markup information; and
wherein analyzing the web page includes determining a term in the natural language query corresponds to the semantic markup information.

3. The computer-based method as in claim 1, further comprising:
analyzing the request to determine a modification identifier; and
determining instructions for applying the modification to the structured data element based on the modification identifier.

4. The computer-based method as in claim 3, wherein the structured data element includes a table;
wherein the modification identifier represents a sort order operation; and
wherein applying the modification to the structured data element satisfying the criterion includes:
rearranging table rows in the table to produce a modified sort order of the table.

5. The computer-based method as in claim 3, wherein the modification identifier corresponds to one operation of a plurality of predefined emphasis operations.

6. The computer-based method as in claim 1, wherein the web page is associated with a document model that includes a set of nodes representing the structured data elements of the web page, and
wherein applying the modification to the structured data element includes:
editing a node of the document model represented by the structured data element that satisfies the criterion to change an appearance of the structured data element.

7. The computer-based method as in claim 1, wherein the modification is obtained from a repository of modifications, the repository including a descriptor of the modification in terms of markup language.

8. The computer-based method as in claim 7, wherein the repository of modifications further includes instructions for applying the modification to the structured data element satisfying the criterion, the instructions including an addition of the markup language to the web page, the markup language including a HTML markup tag.

9. The computer-based method as in claim 1, further comprising:
determining that the criterion includes an element corresponding to information in an external dataset;
obtaining data from the external dataset that corresponds to the element; and
using the data from the external dataset to identify the structured data element that satisfies the criterion.

10. The computer-based method as in claim 9, wherein the external dataset is obtained from a server different from a server transmitting the web page to the web browser.

11. The computer-based method as in claim 9, wherein the external dataset is associated with any of a profile of the user, a search result, or an open browser tab in the web browser.

12. The computer-based method as in claim 9, wherein the web page is received from a web page server;
wherein the external dataset includes private data originating from a private data resource; and
wherein the analyzing and applying occur without transmitting the private data to the web page server.

13. The computer-based method as in claim 1, further comprising:
determining that the criterion includes an element corresponding to a dataset local to a user device configured to run the web browser, the dataset including metadata identifying the dataset, the determining being based on the metadata;
obtaining data from the dataset that corresponds to the element; and
using the data from the dataset to identify the structured data element that satisfies the criterion.

14. The computer-based method as in claim 13, wherein the dataset includes search engine results based on a query submitted to a search engine.

15. A computer program product comprising a non-transitory storage medium, the computer program product including code that, when executed by processing circuitry, causes the processing circuitry to perform a method, the method comprising:
receiving, from a user of a web browser, query data representing a request to modify a presentation of a web page as displayed by the web browser, the web page including structured data elements, the request identifying a criterion;
analyzing the web page to identify a structured data element of the structured data elements that satisfies the criterion; and
modifying the structured data elements satisfying the criterion to produce a modified presentation of the web page as displayed by the web browser.

16. The computer program product as in claim 15, wherein analyzing the web page includes:
identifying the structured data elements of the web page by identifying table elements, list elements, accessibility elements, or semantic markup elements; and
comparing the structured data elements to the criterion.

17. The computer program product as in claim 15, wherein the request further identifies an emphasis operation of a plurality of predefined emphasis operations, and modifying the web page includes applying the emphasis operation to the structured data element satisfying the criterion.

18. The computer program product as in claim 17, wherein the method further comprises:
performing a classification operation on the query data to identify the emphasis operation from the plurality of predefined emphasis operations.

19. The computer program product as in claim 15, wherein the web page includes a table with table elements and the structured data element satisfying the criterion is in a region of the table, and
wherein producing the modified presentation of the web page further comprises:
changing an appearance of the region.

20. An electronic apparatus, the electronic apparatus comprising:
memory; and
processing circuitry coupled to the memory, the processing circuitry being configured to:
receive, from a user of a web browser, query data representing a request to modify a presentation of a web page as displayed by the web browser, the web page including structured data elements, the request identifying a criterion;
analyze the web page to identify a structured data element of the structured data elements that satisfies the criterion; and
modify the structured data elements satisfying the criterion to produce a modified presentation of the web page as displayed by the web browser.

21. The electronic apparatus as in claim 20, wherein the processing circuitry is further configured to:
determine that the criterion includes an element corresponding to information in an external dataset;
obtain data from the external dataset that corresponds to the element; and
use the data from the external dataset to identify the structured data element that satisfies the criterion.

22. The electronic apparatus as in claim 21, wherein the processing circuitry is further configured to:
identify a uniform resource locator (URL) associated with the element; and
access the data at a web resource determined from the URL.

23. The electronic apparatus as in claim 21, wherein the user belongs to an organization; and
wherein the processing circuitry is further configured to:
receive the data from a resource associated with the organization at a point in time prior to receiving the query data.

24. The electronic apparatus as in claim 20, wherein the processing circuitry is further configured to:
transmit, to a second user device, modification data including structured data element identifiers that identify the structured data elements satisfying the criterion and a modification to be applied to structured data elements corresponding to the structured data element identifiers on a web page running on a browser of the second user device.

25. The electronic apparatus as in claim 20, wherein the processing circuitry configured to modify the structured data elements satisfying the criterion is further configured to:
deemphasize a structured data element of the structured data elements that does not satisfy the criterion.

26. The electronic apparatus as in claim 20, wherein the processing circuitry configured to modify the structured data elements satisfying the criterion is further configured to:
provide an interface that enables the user to select from two or more modifications;
receive a selected modification from the interface; and
modify the presentation of the web page as displayed by the web browser using the selected modification.
